(19) United States
(12) Patent Application Publication
(10) Pub. No.: US 2025/0391174 A1
(43) Pub. Date: Dec. 25, 2025

(54) IMAGE RECOGNITION DEVICE

(71) Applicant: TOYOTA JIDOSHA KABUSHIKI KAISHA, Toyota-shi (JP)

(72) Inventor: Masayuki YAMAZAKI, Yokohama-shi (JP)

(73) Assignee: TOYOTA JIDOSHA KABUSHIKI KAISHA, Toyota-shi (JP)

(21) Appl. No.: 19/214,396

(22) Filed: May 21, 2025

(30) Foreign Application Priority Data
Jun. 25, 2024 (JP) 2024-102032

(51) Int. Cl. G06V 20/52; G06V 40/20

(52) U.S. Cl. CPC G06V 20/52; G06V 40/20

(57) ABSTRACT

An image recognition device includes one or more processors configured to perform group action recognition for a group from results of person action recognition. The one or more processors are configured to perform: a person action recognition determination process of, when a first duration in which a person who was present in a past frame image is not present in a newest frame image continuously is less than a first time threshold value, determining that the person action recognition is impossible for the person subjected to determination on the first duration; and a group action recognition determination process of determining that the group action recognition is impossible when a second duration in which the number of persons for whom the person action recognition is determined to be impossible is continuously equal to or more than a number threshold value is equal to or more than a second time threshold value.

### CROSS-REFERENCE TO RELATED APPLICATION

This application claims priority to Japanese Patent Application No. 2024-102032 filed on Jun. 25, 2024, incorporated herein by reference in its entirety.

### BACKGROUND

### 1. Technical Field

The present disclosure relates to an image recognition device that performs group action recognition.

### 2. Description of Related Art

Japanese Unexamined Patent Application Publication No. 2022-187870 (JP 2022-187870 A) discloses a learning device that performs learning for group action recognition.

### SUMMARY

In detection of a person constituting a group for the group action recognition, temporary absence or non-detection of the person may occur due to hiding etc. among persons. In the group action recognition, it is common to exclude an absent or undetected person from the targets of the group action recognition. When the absent or undetected person is simply excluded, however, the accuracy of the group action recognition may decrease.

An image recognition device according to the present disclosure includes one or more processors configured to perform group action recognition for a group from results of person action recognition for a plurality of persons based on time-series frame images generated by a camera that captures images of a space where the group is present. The one or more processors are configured to perform:

a person action recognition determination process of, when a first duration in which a person who was present in a past frame image is not present in a newest frame image continuously is less than a first time threshold value, determining that the person action recognition is impossible for the person subjected to determination on the first duration; and
a group action recognition determination process of determining that the group action recognition is impossible when a second duration in which the number of persons for whom the person action recognition is determined to be impossible is continuously equal to or more than a number threshold value is equal to or more than a second time threshold value.

According to the present disclosure, determination is made that the group action recognition is impossible when the second duration in which the number of persons for whom the person action recognition is determined to be impossible is continuously equal to or more than the number threshold value is equal to or more than the second time threshold value. Therefore, it is possible to suppress immediate determination that the group action recognition is impossible when a person is temporarily absent or undetected. This leads to suppression of the decrease in the accuracy of the group action recognition.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an example of a configuration of an image recognition device according to an embodiment;

FIG. 2 is a flowchart illustrating an example of a flow of processing performed by the image recognition device according to the embodiment;

FIG. 3A is a diagram illustrating an example of a method of setting reliability thresholds;

FIG. 3B is a diagram illustrating an example of a method of setting reliability thresholds;

FIG. 4A is a diagram for explaining an exemplary method of acquiring time-threshold Tth3 used in S120 of FIG. 2;

FIG. 4B is a diagram for explaining an exemplary method of acquiring time-threshold Tth3 used in S120 of FIG. 2;

FIG. 5A is a table showing each example of the action recognition result of each person collected by the processing of S126 in FIG. 2; and

FIG. 5B is a chart showing examples of each person's behavior recognition results collected by S126 process of FIG. 2.

### DETAILED DESCRIPTION OF EMBODIMENTS

Embodiments of the present disclosure will be described with reference to the accompanying drawings.

### 1. Configuration of Image Recognition Device

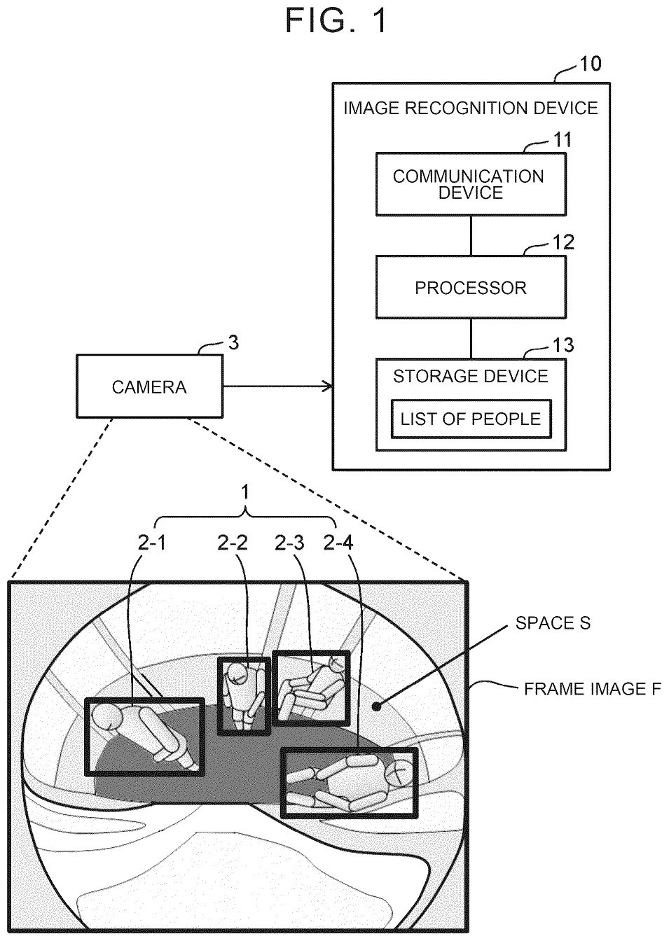

FIG. 1 is a diagram schematically illustrating an example of a configuration of an image recognition device 10 according to an embodiment.

The image recognition device 10 acquires a time-series frame image F generated by the camera 3 that captures the space S in which the group 1 exists. The group 1 is composed of a plurality of persons 2 (2-1 to 2-N: N is an integer of 2 or more). FIG. 1 illustrates an example of a frame image F. The space S is, for example, a passenger compartment of a moving object such as a vehicle. As an example of the plurality of persons 2, four passengers 2-1 to 2-4 are shown in the frame image F. The camera 3 is mounted on, for example, a moving body. The image recognition device 10 is configured to perform group action recognition of the group 1 based on the result of the person action recognition of the plurality of persons 2 based on the time-series frame images F.

The image recognition device 10 includes a communication device 11, one or a plurality of processors 12 (hereinafter, simply referred to as a processor 12), and one or a plurality of storage devices 13 (hereinafter, simply referred to as a storage device 13). The communication device 11 communicates with a mobile object via a communication network, and acquires a time-series frame image F generated by the camera 3.

The processor 12 executes various processes. Examples of the processor 12 include a general-purpose processor, a special-purpose processor, a CPU (Central Processing Unit), a GPU (Graphics Processing Unit), an ASIC (Application Specific Integrated Circuit), an FPGA (Field-Programmable Gate Array), and the like. The storage device 13 stores various kinds of information necessary for various kinds of processing. Examples of the storage device 13 include volatile memory, non-volatile memory, HDD (Hard Disk Drive), SSD (Solid State Drive), and the like.

The processor 12 executes a computer program. The computer program is stored in the storage device 13. The computer program may be recorded in a computer-readable recording medium. The functions of the image recognition device 10 are realized by the cooperation of the processor 12 executing the computer program and the storage device 13. The functions realized in this way include functions as a person detector (see S102), the same person determiner (see S104), and an action recognizer (see S108), which will be described later.

The storage device 13 stores a person list. The person list includes various pieces of person information regarding each person 2 detected from the frame image F. The person information includes, for example, information on a person ID (Identification), information on a frame number of the frame image F in which the person 2 is detected, and person-specific action type information described later.

### 2. Processing of Image Recognition Device

When a person constituting a group is detected for group action recognition, a temporary absence or non-detection of a person may occur due to a hiding or the like between persons. In group action recognition, it is common to exclude persons who are absent or undetected from the group action recognition. However, if an absent or undetected person is simply excluded, the accuracy of the collective action recognition may decrease. Here, the “absence” of a person means that the person is not detected because the person is present in a space captured by the camera but is not reflected in the camera due to a reason such as being hidden by another person. “Not detected” means that a person appearing in the camera is not detected.

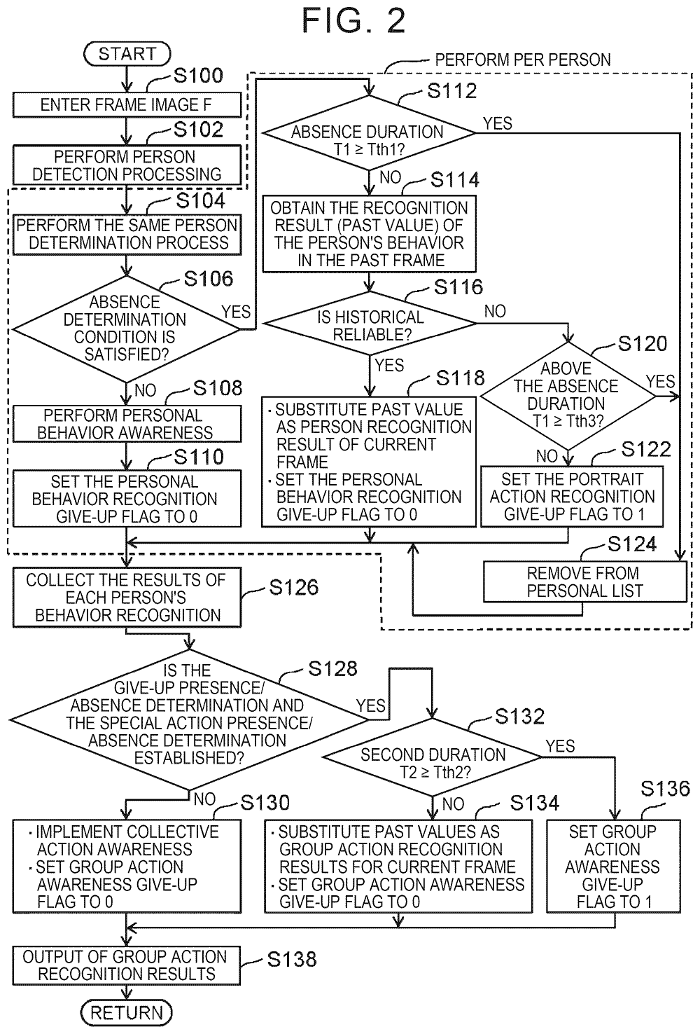

FIG. 2 is a flowchart illustrating an example of a flow of processing performed by the image recognition device 10 according to the embodiment. The processing of this flowchart is executed by the image recognition device 10 (the processor 12) in response to the acquisition request of the collective action recognition result. In an example in which the group 1 is a passenger of a moving body (see FIG. 1), the acquisition request is transmitted from the moving body to the image recognition device 10. More specifically, the camera 3 acquires the frame images F at predetermined frame rates (e.g., 2 fps or higher).

Upon receiving the above-described acquisition request, the image recognition device 10 sequentially receives the frame images F from the camera 3, and stores the received frame images F in the storage device 13. The image recognition device 10 (processor 12) repeatedly executes the processing of this flowchart for each of the time-series individual frame images F.

In S100, the processor 12 inputs the newest frame image F (i.e., the current frame image F) to the person detector. Then, in S102, the processor 12 (person detector) performs a person detecting process of detecting the person 2 (appearing) present in the current frame image F. In the person detection process, a machine learning model learned in advance and stored in the storage device 13 is used. More specifically, the processor 12 detects a rectangular image area (see FIG. 1) surrounding the person 2 present in the current frame image F. Such a person detection process is a well-known technique, and the technique is not particularly limited. The processor 12 stores, for example, a partial image obtained by cutting the current frame image F in the detected rectangular image region in the storage device 13.

After S102, the process proceeds to S104. The process of S124 from S104 is executed one by one for all the persons 2 registered in the person list, including the person 2 which can be newly detected by the process of the present S102. In the following explanation, the person 2 that is the target of S124 process from the currently executed S104 is also referred to as a “recognition-target person 2”.

In S104, the processor 12 (the same person determiner) executes the same person determination process. Specifically, the processor 12 collates the current frame image F with a predetermined number (for example, 10) of the past frame images F retroactively from the current frame image F. As a result, the processor 12 determines (specifies) the person 2 existing in the current frame image F among the persons 2 existing in the past frame image F. Such an identical person determination process can be performed using, for example, a well-known person re-identification (Person ReID (Re-Identification)) technique.

More specifically, the storage device 13 stores a partial image of each person 2 included in each of the current frame image F and the predetermined number of past frame images F, and a ReID model based on machine-learning. The processor 12 performs the same person determination process using the partial image of the recognition-target person 2 included in the current frame image F, the partial image of the person 2 included in each of the predetermined number of past frame images F, and ReID modeling. In addition, when a new person 2 is detected as a result of the same person determination process, the processor 12 adds the detected person 2 to the person list (see FIG. 1).

In S106 subsequent to S104, the processor 12 determines whether or not the absence determination condition is satisfied, for example, by using the information of the person list. The absence determination condition is that the recognition target person 2 is detected from at least one of the predetermined number of past frame images F and is not detected from the current frame image F. When the recognition-target person 2 is detected from the current frame images F, that is, when the absence determination condition is not satisfied (S106; No), the process proceeds to S108.

In S108, the processor 12 (action recognizer) performs person action recognition of the recognition target person 2. Person behavior recognition can be performed using a well-known behavior recognition technique using a machine learning model. Specifically, the storage device 13 further stores an action recognition model based on machine learning. The processor 12 uses the partial image of the recognition target person 2 included in the current frame image F, the partial image of the recognition target person 2 included in the past frame image F, and the action recognition model to perform the person action recognition of the recognition target person 2.

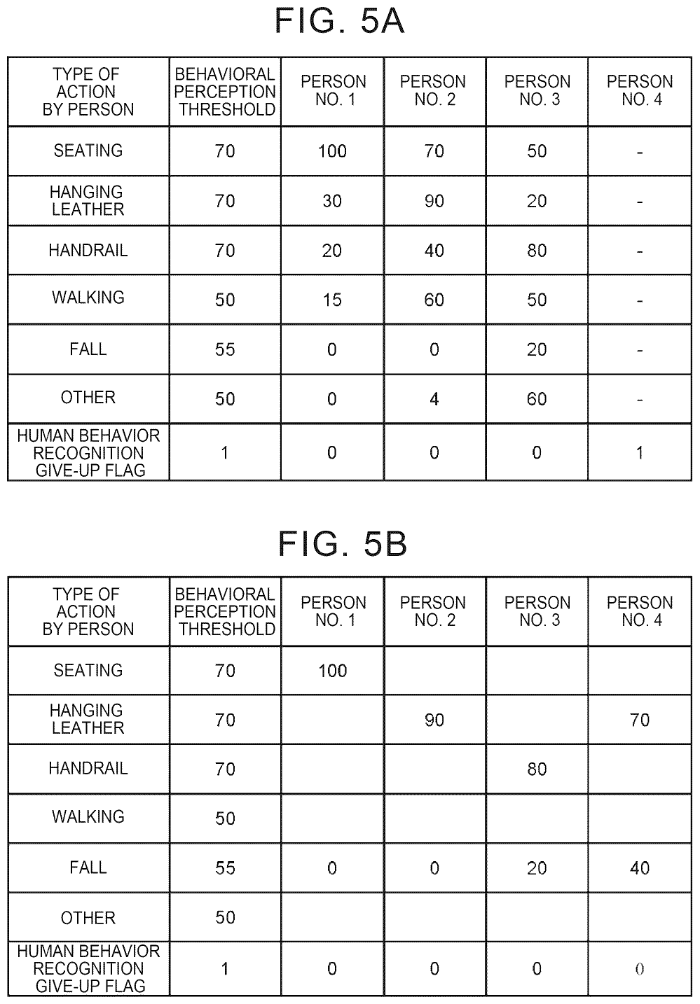

More specifically, S108 process includes a reliability R outputted from the action recognition model for each “person action type” for specifying the action of the recognition target person 2. The reliability R indicates the certainty (in other words, the likelihood) of the recognition result for each of the person behavior types, and is outputted as a numerical value of, for example, 0 to 100 (for example, refer to FIG. 5A described later). The individual person behavior types in the case where the person 2 is a passenger of a moving body are, for example, “sitting”, “hanging leather”, “handrail”, “walking”, “falling”, and “other”, as shown in FIG. 5A. “Seated” indicates that the person 2 is seated in the seat. The “hanging leather” and the “handrail” indicate that the person 2 is standing holding the hanging leather and the handrail, respectively. “Walking” indicates that the person 2 is walking in the guest room. “Fall” indicates that the person 2 is falling in the guest room. The “other” comprehensively indicates the action of the person 2 that does not correspond to any of the five actions of “sitting” to “falling” described above.

The processor 12 stores the person behavior recognition result obtained in S108 (that is, the information on the reliability R for each person behavior type based on the current frame image F) in the storage device 13 as the person behavior type information. The person action type information is included in the person list, for example.

In S110 following S108, the processor 12 sets the person behavior awareness give-up flag to 0. The information indicating the state (0 or 1) of the set person action recognition give-up flag is stored in the storage device 13, for example, as information included in the person action type information.

On the other hand, if the absence determination condition is satisfied (S106; Yes), the process proceeds to S112. In S112, the processor 12 determines whether the absence duration T1 (first duration) is greater than or equal to a predetermined time threshold Tth1 (first time threshold). The absence duration T1 corresponds to a duration of a state in which the recognition-target person 2 is not present in the newest frame image F (that is, a state in which the absence determination condition is satisfied) in the past frame image F. The absence duration T1 is counted by, for example, a timer of the processor 12, but may be calculated using the number of frames and the frame rate at which the absence of the recognition-target person 2 continues. If the absence duration T1 is less than the time-threshold Tth1 (S112; No), the process proceeds to S114.

In S114, the processor 12 acquires the person behavior recognition result (past value) of the past frame. Specifically, the processor 12 reads out the corresponding person behavior type information, that is, the information of the reliability R for each person behavior type based on the latest past frame image F in which the recognition target person 2 exists, from the storage device 13. Thereafter, the process proceeds to S116.

In S116, the processor 12 determines whether or not the person behavior recognition result of the read past frame is reliable. The determination condition is satisfied when at least one of the reliability R of the person behavior recognition result for each person-specific behavior type based on the past frame image F is equal to or greater than a predetermined reliability threshold Rth and the person behavior recognition give-up flag of the past value is 0. In the following description, the reliability R of the person action recognition result based on the past frame image F is also simply referred to as a “past value of the reliability R”.

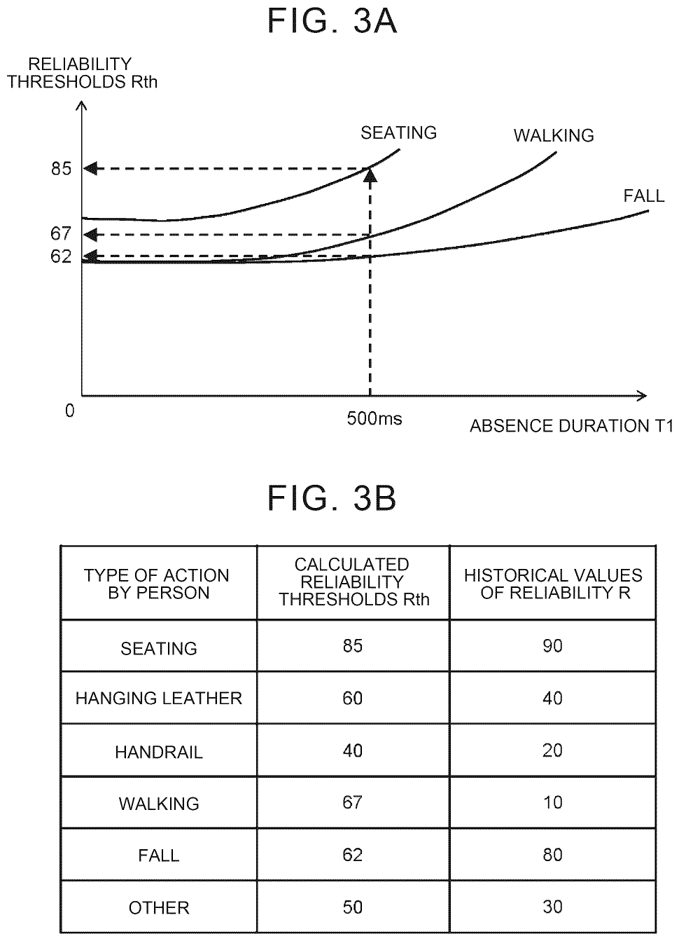

FIGS. 3A and 3B are diagrams for describing exemplary methods of setting the reliability thresholds Rth used in S116. FIG. 3A shows the relation between the reliability thresholds Rth and the absence duration T1 for the historical reliability R. FIG. 3B shows an example of calculation of the numerical value of the reliability threshold Rth when the absence duration T1 is a certain value (for example, 500 ms) for each person-specific action type together with an example of the past value of the reliability R.

As shown in FIG. 3A, the reliability thresholds Rth are determined to differ according to the person-specific action type (sitting, walking, falling, and the like). This is because the case of change in the action of the person 2 varies depending on the person-specific action type. According to this setting example, it is possible to appropriately evaluate the past value of the reliability R considering the changeability of the behavior of the person 2.

In addition, the reliability thresholds Rth are determined to differ according to the absence duration T1. More specifically, as shown in FIG. 3A, the reliability thresholds Rth for each of the person-specific action types are determined to increase with the passage of the absence duration T1. This is because the characteristics of the tendency of the person 2 to change the behavior with respect to the elapse of time differ depending on the person-specific behavior type. For example, it takes some time for a fallen person to get up. In contrast, it takes less time for a person to sit up or stand up. According to this setting, considering the property of the changeability of the person 2′s behavior over the course of the absence duration T1, it is possible to appropriately evaluate the historical value of the reliability R. In addition, the reliability thresholds Rth regarding the person-specific behavior type (e.g., walking) for which higher attention is required for securing the safety of the person 2 who is the passenger of the mobile object may be determined as follows. In other words, the reliability threshold Rth may be determined such that the increased quantity of the reliability threshold Rth with respect to the lapse of the absence duration T1 is larger than the reliability threshold Rth with respect to the person-specific action type for which higher attention is not required.

The storage device 13 stores information indicating the above-described relation between the person-specific action type, the absence duration T1, and the reliability thresholds Rth. Based on this information, the processor 12 calculates a reliability threshold Rth corresponding to the absence duration T1 at the time of executing S116 process for each person-specific action type.

If the historical values are reliable (S116; Yes), the process proceeds to S118. In S118, the processor 12 substitutes the person behavior recognition result of the past frame as the person behavior recognition result of the current frame. As a result, the past value is stored in the storage device 13 as the person action type information indicating the person action recognition result of the current frame. In addition, in S118, the processor 12 sets the person behavior recognition give-up flag to 0 in the same manner as in S110.

On the other hand, when the past value is unreliable (S116; No), that is, when all of the reliability R of the person behavior recognition result for each person type is less than the reliability threshold Rth or when the person behavior recognition give-up flag is 1, the process proceeds to S120. In S120, the processor 12 determines whether the absence duration T1 is greater than or equal to a predetermined time-threshold Tth3. This time-threshold Tth3 corresponds to a time (forgetting time) for determining whether or not to delete a person 2 having a long absence duration T1 from the person-list.

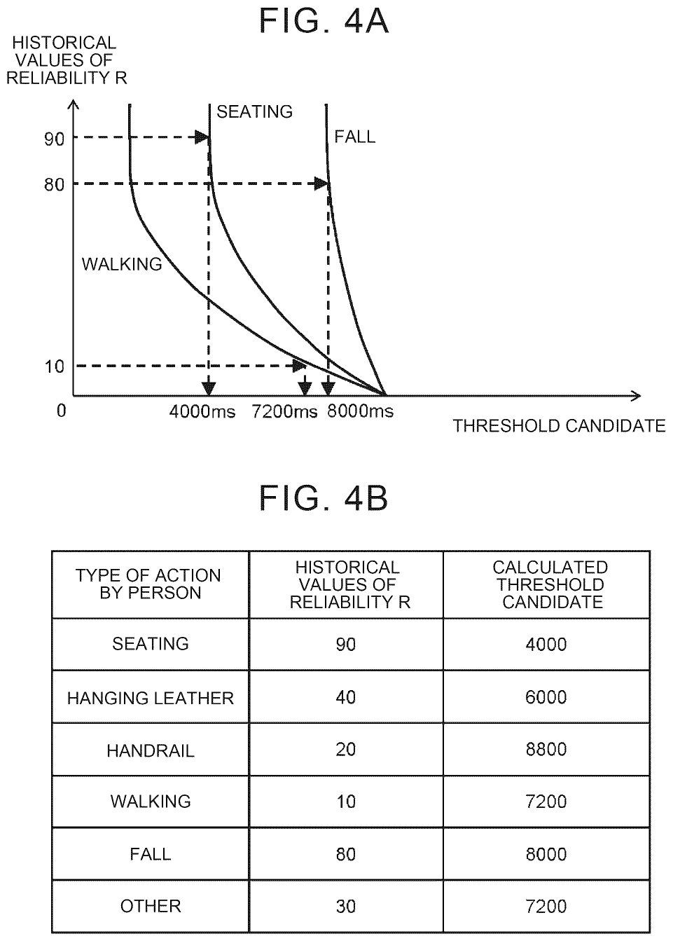

FIGS. 4A and 4B are diagrams for describing exemplary methods of acquiring the time-threshold Tth3 used in S120. FIG. 4A shows the relation between the historical value of the reliability R (more specifically, the reliability R of the final action of the person 2 prior to being absent) and the “potential thresholds” for each person-specific action type (e.g., walking, sitting down, falling). Here, the threshold candidate is a candidate of the time threshold Tth3 (forgetting time). FIG. 4B shows an exemplary calculation of the numerical values of the threshold candidates based on the historical values of the reliability R for each person-specific action type.

The threshold candidate for each person-specific action type is determined in consideration of the difference in the case of frame-out of the person 2 according to the person-specific action type and the magnitude of the past value of the reliability R. Specifically, for example, the walking person 2 is more likely to frame out than at the time of falling. Therefore, when the past value of the reliability R regarding “walking” is high, it can be considered that there is a sufficient possibility that the person 2 is separated from the space S as a reason for the absence. Therefore, as shown in FIG. 4A, with respect to “walking”, the threshold candidates are set to be shorter when the historical reliability R is higher. On the other hand, in a case where the past value of the reliability R regarding “fall” is high, it can be considered that the person 2 continues to be reflected on the camera 3 without moving from the place, but there is a sufficient possibility that it is undetected by the person detection process. Therefore, as shown in FIG. 4A, with respect to “falling”, the threshold candidates are set to be longer when the historical reliability R is higher. On the other hand, when the past value of the reliability R is low for each of the person-specific action types, it is difficult to deterministically determine the person action recognition result. Therefore, as shown in FIG. 4A, the respective threshold candidates for the person-specific action types are set to be longer as the reliability R decreases.

The storage device 13 stores information indicating the above-described relationship between the person-specific action type, the past value of the reliability R, and the threshold candidate. Based on the information, the processor 12 calculates a threshold candidate corresponding to the past value of the reliability R for each person-specific action type. Then, the processor 12 acquires the smallest of the calculated threshold candidates as the temporal threshold Tth3. In the exemplary embodiment shown in FIG. 4B, the processor 12 obtains 4000 ms as a time-threshold Tth3.

If the absence duration T1 is less than the time-threshold Tth3 (S120; No), the process proceeds to S122. In S122, the processor 12 determines that the person behavior recognition of the current recognition target person 2 (that is, the person 2 to be determined in the absence duration T1) is impossible, and sets the person behavior recognition give-up flag to 1. In FIG. 2, S106-S122 process corresponds to the “person action recognition determination process” according to the present disclosure.

On the other hand, when the absence duration T1 is equal to or greater than the time threshold Tth1 (S112; Yes) or when the absence duration T1 is equal to or greater than the time threshold Tth3 (S120; Yes), the process proceeds to S124. In S124, the processor 12 deletes the current recognition target person 2 from the person list. That is, since the absence duration T1 is long, the person information regarding the person 2 whose necessity to be recognized is sufficiently reduced is deleted from the storage device 13. Thus, the processing load of the image recognition device 10 can be reduced. In addition, according to the processes of S112-S116 and S120, when the absence duration T1 is less than the time threshold Tth1, it is possible to appropriately determine the time when the person information is to be deleted from the person list by considering the past value of the reliability R.

In FIG. 2, when the process of S124 is completed from S104 for all the persons 2 registered in the person list, the process proceeds to S126. S126 and subsequent processes are executed once for one frame image F. First, in S126, the processor 12 reads out the action recognition results of the respective persons 2 from the storage device 13. Thereafter, the process proceeds to S128.

In S128, the processor 12 determines whether the give-up presence/absence determination and the special action presence/absence determination are satisfied. The give-up presence/absence determination is established when the number of the persons 2 whose person behavior recognition give-up flag is 1 (that is, the number of the persons 2 determined to be unable to recognize the person behavior) is equal to or larger than a predetermined number threshold value Nth. The special action presence/absence determination is established when there is no person 2 of the special action. The special action is, for example, a “fall”.

FIG. 5A is a table showing an example of the action recognition result of each person 2 collected by S126 process, and is used here to explain the give-up presence/absence determination and the special action presence/absence determination. In this table, the person behavior recognition results (i.e., the numerical value of the reliability R) of the four persons 2 (from No. 1 to No. 4) are represented for each person behavior type. The table also shows the state (0 or 1) of the person behavior recognition give-up flag. In addition, since the person No. 4 has the person action recognition give-up flag set to 1, it does not have the numerical value of the reliability R for each person action type. Furthermore, the table also shows an action recognition threshold value that is set in advance for each person-specific action type. Among the person action recognition results represented in this table, a person action recognition result having a numerical value equal to or larger than the action recognition threshold value may be a target of group action recognition described later. For example, with respect to the person No. 1, the recognition-result (numerical value: 100) of “sitting down” may be an object. Regarding the person No. 2, the recognition result of “sitting” (numerical value: 70), the recognition result of “hanging leather” (numerical value: 90), and the recognition result of “walking” (numerical value: 60) can be targeted. Regarding the person No. 3, the recognition result of “handrail” (numerical value: 80), the recognition result of “walking” (numerical value: 50), and the recognition result of “others” (numerical value: 60) may be targeted.

The number threshold value Nth used for the give-up determination is not particularly limited, but may be calculated to be ¼ of the number of detected persons 2 (including the person 2 not present but not including the person 2 to be forgotten), for example. In the embodiment shown in FIG. 5A, the number of detected persons is four, and thus the number threshold value Nth is 1. Then, the person 2 whose person action recognition give-up flag is 1 is 1 (No. 4). Therefore, in the embodiment shown in FIG. 5A, the processor 12 determines that the give-up determination is satisfied.

In addition, with respect to the special action presence/absence determination, the processor 12 identifies the person 2 having the reliability R equal to or higher than the action recognition threshold (fall threshold) with respect to the “fall” as the person 2 of the special action. In the example shown in FIG. 5A, since there is no person 2 having the reliability R equal to or higher than the behavior recognition threshold value (for example, 55) with respect to the “fall”, the processor 12 determines that the special behavior presence/absence determination is not satisfied.

When at least one of the give-up presence/absence determination and the special action presence/absence determination is not satisfied (S128; No), the process proceeds to S130. In S130, the processor 12 performs collective action recognition based on the current frame image F.

FIG. 5B is a table showing another example of the action recognition result of each person 2 collected by the process of S126, and is used here to explain the group action recognition. For the tables shown in FIG. 5A, the tables shown in FIG. 5B are the same in the person behavior recognition results of three persons (No. 1 to No. 3), and are different in the person behavior recognition results (reliability R and give-up flag) of the fourth person 2 (No. 4). According to the person behavior recognition result shown in the table shown in FIG. 5B, the give-up presence/absence determination is not satisfied, and the fall determination is also not satisfied. Note that in FIG. 5B, a part of the reliability R of the respective persons 2 is not displayed.

In the group action recognition in S130, the processor 12 selects the recognition result having the highest reliability R among the person action recognition results of the respective persons 2. In the embodiment shown in FIG. 5B, the recognition result (numerical value: 100) of “sitting” is selected with respect to the person No. 1. Regarding the person No. 2, the recognition result (numerical value: 90) of the “hanging leather” is selected. With respect to the person No. 3, the recognition result (numerical value: 80) of the “handrail” is selected. With respect to the person No. 4, the recognition result (numerical value: 70) of the “hanging leather” is selected.

In the case where the group 1 is a passenger of a moving body, the group action type determined in the group action recognition is, for example, “all seats”, “all seats or hanging leather gripping or handrail grip”, and “there is a falling person”. Supplementarily, “all persons sitting or hanging leather gripping or handrail gripping” indicates that the person-specific action types of all the recognized persons 2 are either “sitting”, “hanging leather”, or “handrail”.

In the case shown in FIG. 5B, the person-specific action type of the selected recognition-result is any one of “sitting down”, “hanging leather”, or “handrail” in all of the detected persons 2 (No. 4 from No. 1). Thus, in this instance, the processor 12 recognizes “all-seated or hanging leather gripping or handrail gripping” as the action of the group 1. In other words, the processor 12 acquires “all-seated or hanging leather gripping or handrail gripping” as a group action recognition result based on the current frame image F.

In addition, unlike the example shown in FIG. 5B, if the recognition result selected in all the detected persons 2 (No. 4 from No. 1) is “sitting”, the processor 12 acquires “all sitting” as the group action recognition result. Further, unlike the example shown in FIG. 5B, when there are one or more persons 2 whose reliability R regarding “falling” is equal to or greater than the action recognition threshold value (for example, 55), the processor 12 acquires “with falling person” as the group action recognition result.

In addition, in S130, the processor 12 sets the collective action awareness give-up flag to 0. The processor 12 stores the group action recognition result obtained as described above in the storage device 13 together with the information indicating the state (0 or 1) of the set group action recognition give-up flag.

On the other hand, when both the give-up presence/absence determination and the special action presence/absence determination are established (S128; Yes), the process proceeds to S132. In S132, the processor 12 determines whether the second duration T2 is greater than or equal to a predetermined time threshold Tth2 (second time threshold).

The second duration T2 corresponds to a duration in which the number of the persons 2 determined to be unable to recognize the person's behavior is equal to or larger than the number threshold value Nth. The second duration T2 is counted, for example, by a timer of the processor 12, but may be calculated using the number of frames and the frame rate at which the condition continues.

If the second duration T2 is less than the time-threshold Tth2 (e.g., 2000 ms) (S132; No), the process proceeds to S134. In S134, a group action recognition result (that is, a past value) based on the past frame image F (for example, the latest past frame image F) is substituted as a group action recognition result of the current frame. As a result, the past value is stored in the storage device 13 as the collective action recognition result of the current frame. In addition, in S134, the processor 12 sets the collective action awareness give-up flag to 0 as in S130.

On the other hand, if the second duration T2 is greater than or equal to the time threshold Tth2 (S132; Yes), the process proceeds to S136. In S136, the processor 12 determines that the collective action recognition is not possible and sets the collective action recognition give-up flag to 1. In FIG. 2, the process of S126 to S136 corresponds to the “group action recognition determination process” according to the present disclosure.

After S130, S134, or S136, the process proceeds to S138. In S138, the processor 12 outputs (transmits) the collective action recognition result of the current frame to the use destination. In an example in which the group 1 is a passenger of a mobile object, the use destination is, for example, the mobile object. In addition, the collective action recognition result is used, for example, for determining a start in a mobile body that can automatically travel. The mobile object is determined to be able to start when the group action recognition result is “all-seated” or “all-seated or hanging leather gripping or handrail gripping”. In addition, since the group action recognition result to be output to the user includes “there is a falling person”, the user can grasp the presence of the falling person and promptly take measures such as rescue of the falling person.

In addition, the process illustrated in FIG. 2 may be simplified as follows. That is, if S114-S120 process is omitted and the absence duration T1 is less than the time-threshold Tth1 (S112; No), the process may proceed directly to S122.

### 3. Effect

As described above, according to the image recognition device 10 of the present embodiment, the second duration T2 in which the number of persons determined to be unable to recognize the person's behavior is equal to or larger than the number threshold value Nth continues may be equal to or larger than the time-threshold Tth2. In this case, it is determined that the collective action recognition is impossible. As a result, it is possible to prevent the group action recognition from being determined to be impossible immediately when the person 2 that is temporarily absent or undetected occurs. This leads to the suppression of the deterioration of the accuracy of group behavior recognition.

More specifically, according to the present embodiment, when the absence duration T1 is less than the time-threshold Tth1, if the past value of the reliability R is high, the person action recognition result of the past frame is substituted as the person action recognition result of the current frame. On the other hand, if the past value of the reliability R is low, it is determined that the person behavior recognition is impossible. As a result, when the person 2 that is temporarily absent or undetected occurs, the group action recognition can be appropriately continued by substituting the person action recognition result of the past frame.

Further, according to the present embodiment, when the second duration T2 is less than the time-threshold Tth2, the group action recognition result of the past frame is substituted as the group action recognition result of the current frame. As a result, when the person 2 that is temporarily absent or undetected occurs, the group action recognition result of the past frame can be substituted to provide robustness to the group action recognition.

What is claimed is:

1. An image recognition device comprising one or more processors configured to perform group action recognition for a group from results of person action recognition for a plurality of persons based on time-series frame images generated by a camera that captures images of a space where the group is present, wherein
the one or more processors are configured to perform:
a person action recognition determination process of, when a first duration in which a person who was present in a past frame image is not present in a newest frame image continuously is less than a first time threshold value, determining that the person action recognition is impossible for the person subjected to determination on the first duration; and
a group action recognition determination process of determining that the group action recognition is impossible when a second duration in which the number of persons for whom the person action recognition is determined to be impossible is continuously equal to or more than a number threshold value is equal to or more than a second time threshold value.

2. The image recognition device according to claim 1, wherein the one or more processors are configured to, when the first duration is less than the first time threshold value in the person action recognition determination process:
when a reliability of a result of the person action recognition based on the past frame image is high, use the result of the person action recognition based on the past frame image as a substitute for a result of the person action recognition based on the newest frame image; and
when the reliability is low, determine that the person action recognition is impossible.

3. The image recognition device according to claim 1, wherein the one or more processors are configured to, when the second duration is less than the second time threshold value in the group action recognition determination process, use a result of the group action recognition based on the past frame image as a substitute for a result of the group action recognition based on the newest frame image.

4. The image recognition device according to claim 2, wherein a reliability threshold value for determination as to whether the reliability is high or low differs depending on person-specific action types for identifying actions of the persons.

5. The image recognition device according to claim 2, wherein a reliability threshold value for determination as to whether the reliability is high or low differs depending on the first duration.
